(19) United States
(12) Patent Application Publication
(10) Pub. No.: US 2014/0069972 A1
(43) Pub. Date: Mar. 13, 2014

(54) METHOD AND APPARATUS FOR MOUNTING CNG/ANG TANKS TO HEAVY TRUCKS

(71) Applicant: Alternative Fuel Containers, LLC (KSR Technologies Co.), Ridgetown (CA)

(72) Inventor: Larry G. Willemsen, Morpeth (CA)

(73) Assignee: Alternative Fuel Containers, LLC (KSR Technologies Co.), Ridgetown (CA)

(21) Appl. No.: 14/022,569

(22) Filed: Sep. 10, 2013

Related U.S. Application Data
(60) Provisional application No. 61/698,861, filed on Sep. 10, 2012.

(51) Int. Cl. B60R 9/06

(52) U.S. Cl. CPC B60R 9/06
USPC 224/401

(57) ABSTRACT

A system and method for storing fuel on a semitrailer truck vehicle. The system includes a fairing mounted to the exterior surface of a vehicle. The fairing includes an outer surface to deflect air as the vehicle moves forward. The fairing further includes an inner surface forming a cavity. A fuel tank, or a plurality of fuel tanks are provided to mount within the cavity of the fairing. The fuel tanks are specifically adapted to hold CNG or ANG fuel.

### CROSS-REFERENCE TO RELATED APPLICATIONS

This application claims priority of U.S. Provisional Application 61/698,861 filed Sep. 10, 2012, the contents of which are incorporated herein by reference.

### FIELD OF THE INVENTION

The present invention relates generally to fuel tank storage. More particularly, this invention relates to positioning of a fuel tank under a preexisting fairing.

### BACKGROUND OF THE INVENTION

It is known to mount a fairing to the cab of a semitrailer truck to reduce turbulence and wind resistance. The fairing extends from the front of the roof of the cab at an angle upwardly towards a position equal or close to the height of the semitrailer over the rear. The fairing provides an aerodynamic flow path for the air flow generated by the forward movement of the truck through the air. The fairing may be either an integral part of the original vehicle or added as an aftermarket piece of equipment. Fairings are typically made of a rigid, lightweight material such as aluminum or composite material.

It is known to use compressed natural gas (CNG) or absorbed natural gas (ANG) to power heavy trucks. However, the use of CNG and ANG requires special tankage built to withstand the pressure of the compressed natural gas contained within the tanks. They tanks are frequently large and have strict size and structural requirement for which existing fuel tank locations (under the vehicle) are not appropriate. The existing truck fuel tanks for gasoline or diesel are of insufficient strength to withstand the pressure necessary to safely transport CNG or ANG. Further, the existing positions of fuel tanks for gasoline or diesel within a truck are commonly not large enough or physically capable of accepting one or a plurality of CNG or ANG tanks. As such, there exists a need in the art to provide a storage space for CNG or ANG tanks for use with a truck.

### SUMMARY OF THE INVENTION

The present invention provides for a system and method for storing fuel on a semitrailer truck vehicle. The system includes a fairing mounted to the exterior surface of a vehicle, typically on the roof of a semitrailer truck. The fairing includes an outer surface to deflect air as the vehicle moves forward. The fairing further includes an inner surface forming a cavity. A fuel tank, or a plurality of fuel tanks are provided to mount within the cavity of the fairing. The fuel tanks are specifically adapted to hold CNG or ANG fuel. Due to the preset space restrictions in preexisting vehicles, the CNG or ANG tanks are not capable of fitting within the standard gas or diesel tank storage areas. Furthermore, CNG or ANG tanks require significantly more storage space which preexisting gasoline or diesel storage areas are not capable of handling. Even further, ANG and CNG storage tanks have strict structural and dimensional configurations required due to the high pressure nature of CNG and ANG tank fuels. As such, CNG and ANG fuel tanks must be specially handled and stored so as to not damage or disrupt the CNG or ANG tank.

At least one fuel tank is provided operable to hold a CNG or ANG fuel. The fuel tank is positioned within the cavity of the fairing positioned on the roof of a semitrailer truck vehicle. The fuel tank is fluidly connected to a filling line and a supply line. The filling line connected to the at least one tank is further connected to a filling port allowing the user to easily access the fuel. The filling port is typically located on an external surface of the vehicle. The supply line connected to the fuel tank is further connected to the engine of the vehicle. The supply line connects the fuel tanks to the engine to supply fuel from the fuel tanks to the engine for operation of the engine.

A cradle or chock is mounted to the exterior surface of the vehicle. In a typical embodiment, the cradle is mounted to the roof of the vehicle under the fairing in the cavity of the fairing. The cradle includes an upper surface adapted to mount and cradle the at least one fuel tank. The cradle includes a plurality of semicircular indentations allowing the outer surface of the fuel tank to rest securely within the cradle. A strap or other fastener is provided to extend over the fuel tanks to secure the fuel tanks to the cradle.

A method of the present invention includes a method for storing fuel on a semitrailer truck vehicle. The method includes the steps of attaching a cradle to the roof of a semitrailer truck vehicle wherein the cradle is positioned under a fairing of the vehicle. The method further includes the step of mounting at least one fuel tank to the cradle wherein the at least one fuel tank rests snugly within the cradle. The at least one fuel tank is then secured to the cradle of the vehicle by means of a strap or other fastener. The method then includes the step of connecting a fill line to the at least one fuel tank wherein the fill line is connected to a filling port on the vehicle and then connecting a supply line to the at least one fuel tank wherein the supply line is connected to the engine within the vehicle.

### BRIEF DESCRIPTION OF THE DRAWINGS

FIG. 1 illustrates a perspective view of a semitrailer truck vehicle including a plurality of fuel tanks stored within the fairing of a vehicle;

FIG. 2 illustrates a perspective view of a typical CNG tank;

FIG. 3 illustrates a perspective exploded view of the cradle assembly, strap, and plurality of fuel tanks; and

FIG. 4 illustrates a side view and schematic arrangement of the semitrailer truck vehicle including the plurality of fuel tanks stored transversely across the vehicle.

### DETAILED DESCRIPTION OF THE INVENTION

The present invention provides for a method and system for storing specifically CNG and ANG fuel within or on a vehicle. A fuel tank or plurality of fuel tanks are mounted on the roof of the vehicle under the preexisting cavity on the fairing of a semitrailer truck vehicle. The system and method of the present invention overcomes the prior art by allowing a large number of fuel tanks to be stored on the external surface of a vehicle thus overcoming the previous space and size restrictions of well known gas and diesel tank storage systems.

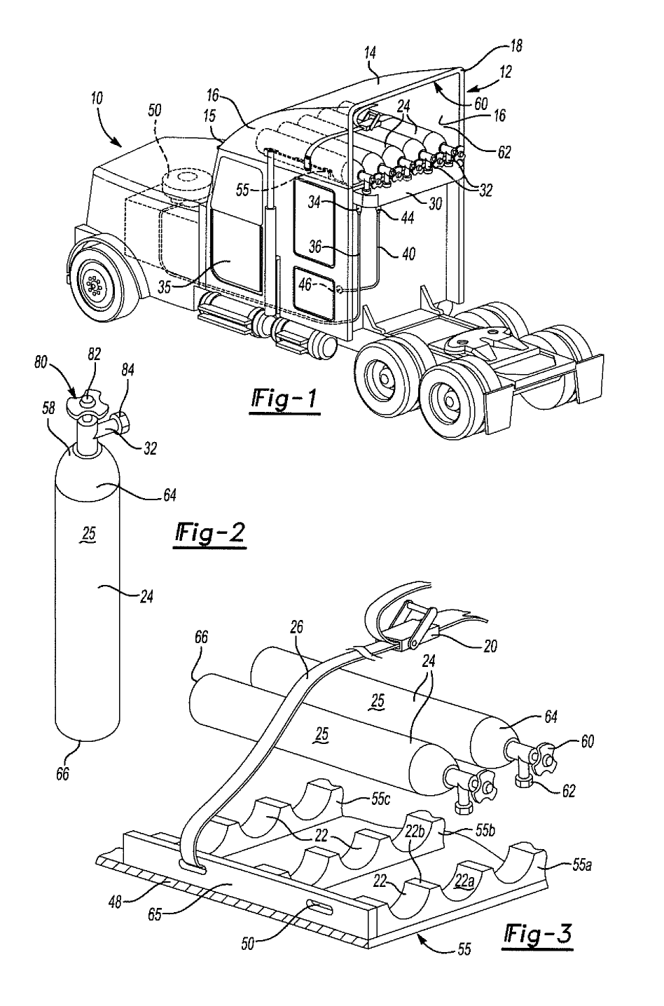

As shown in FIG. 1, a semitrailer truck 10 is used for pulling a semitrailer (not shown). The truck includes a fairing 12 which is generally wedge shaped having a front wall 14 and a pair of side walls 16. The front wall 14 angles upwardly from a front portion 15 of the cab 10 to an elevated position 18 generally equal to the height of the semitrailer over the rear of the truck. In the present embodiment, the front wall 14 is slightly curved allowing air to flow over the front wall 14. In other embodiments, the front wall 14 may be straight and connected to an upper wall.

The side walls 16 are generally coplanar with the door 35 of the truck 10. In the present embodiment, the rear of the fairing 12 is generally open, however, in other embodiments it may be provided with a removable cover (not shown) to permit access to the interior space or cavity 62 within the fairing. The fairing 12 further includes an inner surface 60 which forms the inner cavity 62. The inner cavity 62 is large enough to accommodate a plurality of fuel tanks 24.

The inner cavity 62 of the fairing 12 is formed by the front wall 14 and the pair of side walls 16. The walls 14, 16 are generally solid including a smooth outer and inner surface.

The tank 24 includes an outer surface 25 and an upper end 58 and a lower end 66. The outer surface 25 is generally curved and includes a smooth outer surface. The tank 24 is elongated and generally cylindrical. The upper surface 58 of the tank includes a nozzle portion 80 having a handle 82 and a passageway 84. The passageway 84 includes a conduit 32 operable to connect to the interior portion of the tank 24. The tank 24 further includes a tapered portion 64 at the upper end 58 of the tank. The tapered portion 64 tapers to the nozzle portion 80.

The truck 10 includes an engine 50 located within the front portion of the truck 10. Although the present embodiment is shown in use with a semitrailer vehicle truck, similar embodiments may be utilized in smaller vehicles such as cars or light duty trucks.

FIG. 3 illustrates the cradle 55 of the present embodiment. The cradle 55 includes a plurality of semicircular grooves 22 adapted to accept and securely accept the tanks 24. The grooves 22 are disposed on an upper surface 22b and cut into the overall cradle 55. The grooves 22 further include an upper surface 22a. In the present embodiment, the cradle 55 includes a plurality of extended portions 55a, 55b, 55c extending between two side walls 65 (FIG. 3 illustrates a first side wall 65 wherein the second side wall is parallel to and spaced apart from the first side wall 65 by means of the extended portions 55a, 55b, 55c). The extended portions 55, 55b, 55c may rest on a base 48 or may optionally rest directly on the roof of the vehicle 10.

The side walls 65 further include at least one aperture 50 designed to accept end portions of the strap 26. The strap 26 is a flexible strap designed to extend over the plurality of tanks 24. The strap 26 may optionally be an elastic material, rope, or other acceptable means to secure the tanks 24 to the cradle 55. A bracket or other fastener may also be used to secure the tanks 24 to the cradle 55. The strap 26 includes a buckle portion 20 for adjusting the length and securing the strap 26.

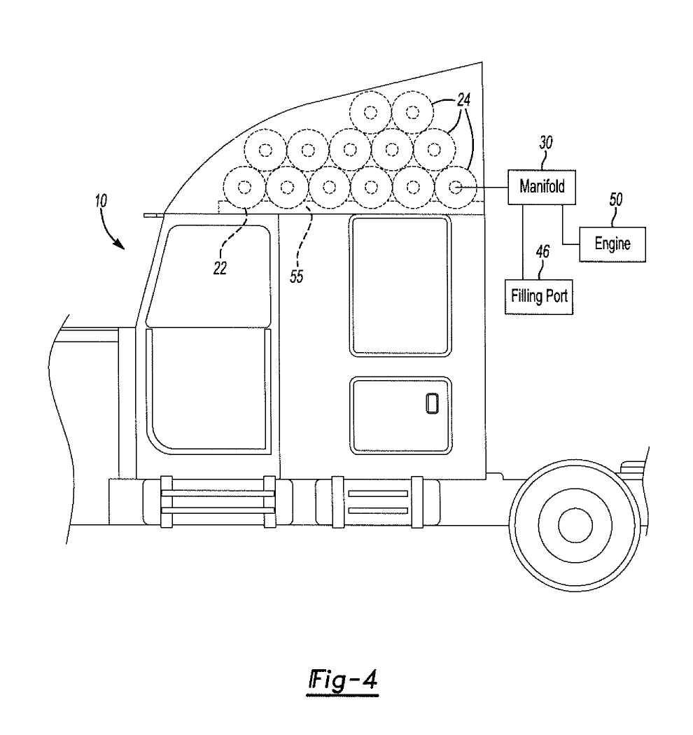

The cradle and tanks may extend longitudinally across the cab so that the tanks are aligned in a fore-and-aft manner (see FIG. 1). Alternatively, the cradle 55 may be positioned in a fore-and-aft manner so as to permit the tanks to be positioned in a transverse alignment, such as shown in FIG. 4.

As shown in FIG. 3, the tanks 24 are secured in position in the cradle with the strap, or plurality of straps 26. The straps are formed of a strong webbing of low stretch material and are secured using the ratchet apparatus 20 allowing the straps to be tightly tensioned to secure the tanks to the cradle.

FIG. 1 illustrates the connection portions of the fuel tanks 24 to the vehicle. A manifold 30 is provided having a plurality of inputs with shutoff valves. The manifold 30 extends across the back of the truck to permit each of the tanks to connect to the inputs/outputs of the manifold 30 by way of the high pressure conduit 32 on the tank 24. The outlet 34 of the manifold 30 is connected to the nozzle 84 and high pressure conduit 32 of the tank 24. The manifold 30 connects directly to the high pressure conduit 32 of the tank 24. The outlet 34 includes a shutoff valve. The outlet 34 is connected to a supply line 36. The supply line 36 is connected to the engine of the vehicle allowing the supply line 36 to carry fuel from the tanks 24 to the engine 50. The supply line 36 may be either enclosed in a housing on the back of the truck 10 or may optionally extend into the B pillar and down the underside of the cab where it continues forward into the engine compartment.

FIG. 4 illustrates the tanks extending in a transverse direction on the upper portion of the cab of the truck vehicle. The manifold 30, the engine 50 and the filling port 46 are all illustrated in FIG. 4 as being connected to the fuel tanks 24. It is appreciated that the figures as illustrated in FIG. 4 is shown for schematic purposes only. It is further appreciated that the manifold 30, the engine 50 and the filling port 50 may be located within the vehicle or attached to the vehicle.

The manifold 30 is further connected to the inlet nozzle 44. The inlet nozzle 44 also connects directly to the high pressure conduit 32 of the tank 24. The inlet 44 is connected to a filling line 40. The filling line 40 may be positioned external to the truck 10 or may also be located within the B pillar of the vehicle. The filling line 40 is connected to a filling port 46. In the present embodiment, the filling port 46 is located on an external surface of the vehicle 10. The filling port 46 allows the user to connect to a supply station external to the vehicle to allow the user to refill the tanks 24.

It is further appreciated that the tanks 24 may all be in fluid connection with each other by means of the manifold 30 or other connection lines. In an alternative embodiment, one inlet/outlet portion is solely connected to the manifold to reduce the number of parts.

The present invention further includes a method for storing fuel on a semitrailer truck vehicle. The method includes the steps of attaching a cradle to the roof of the vehicle wherein the cradle is positioned under a fairing of the vehicle.

The cradle is positioned under a preexisting fairing within a cavity formed by the preexisting walls. The method further includes the step of mounting at least one fuel tank to the cradle wherein the at least one fuel tank rests snugly within the cradle. The method further includes the step of stacking additional fuel tanks on top of the fuel tanks positioned within the cradle to allow for additional tanks to be stored within the fairing. The method then includes the step of securing the at least one fuel tank to the cradle by means of a strap or other fastener. A fill line is connected to the at least one fuel tank wherein the fill line is connected to a filling port on the vehicle. The method then includes the step of connecting a supply line to the at least one fuel tank wherein the supply line is connected to the engine within the vehicle allowing the fuel tanks to supply fuel to the engine of the vehicle. The fuel tanks are also connected to a manifold disposed between the supply line and fill line and the fuel tanks of the vehicle.

The invention is not restricted to the illustrative examples and embodiments described above. The embodiments are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the appended claims.

1. A system for storing fuel on a cab of a truck vehicle, the system comprising:
a fairing mounted to an exterior surface of the vehicle, the fairing having an outer surface to deflect air, the fairing further having an inner surface forming a cavity;
at least one fuel tank, the fuel tank operable to hold a fuel including compressed natural gas or absorbed natural gas, the at least one fuel tank positioned within the cavity of the fairing, the fuel tank fluidly connected to a supply line;
a cradle mounted to the exterior surface of the vehicle, the cradle mounted within the cavity of the fairing, the cradle having an upper surface configured to accept the at least one fuel tank.

2. The system of claim 1 wherein the fairing is positioned on the roof of a vehicle.

3. The system of claim 1 where the cradle is generally semicircular to support one of conventional compressed natural gas and absorbed natural gas tanks.

4. The system of claim 1 wherein the cradle extends transversely across the vehicle.

5. The system of claim 1 wherein the cradle extends in a fore-and-aft direction.

6. The system of claim 1 wherein a fill line is fluidly connected to the at least one fuel tank.

7. The system of claim 1 wherein the at least one fuel tank is secured by a fastener.

8. The system of claim 7 wherein the fastener is a strap.

9. The system of claim 1 wherein the at least one fuel tank is connected to a manifold.

10. The system of claim 9 wherein the supply line is connected to the manifold and in fluid communication with the at least one fuel tank.

11. A method for storing fuel on a semitrailer vehicle, the method comprising the steps of:
attaching a cradle to the roof of the vehicle, the cradle positioned under a fairing of the vehicle;
mounting at least one fuel tank to the cradle, the at least one fuel tank resting snugly within the cradle;
securing the at least one fuel tank to the cradle; and
connecting a supply line to the at least one fuel tank, the supply line connected to the engine within the vehicle to supply fuel to the engine.

12. The method in accordance with claim 11 wherein the fuel tank is secured to the cradle by means of a strap.

13. The method in accordance with claim 11 wherein the at least one fuel tank is connected to a manifold.

14. The method in accordance with claim 13 wherein a fill line is connected to the manifold and in fluid communication with the at least one fuel tank.

15. The method in accordance with claim 13 wherein the supply line is connected to the manifold and in fluid communication with the at least one fuel tank.

16. The method in accordance with claim 14 further including the step of connecting the fill line to the at least one fuel tank, the fill line connected to a filling port on the vehicle.
